(19) United States
(12) Patent Application Publication
(10) Pub. No.: US 2015/0370350 A1
(43) Pub. Date: Dec. 24, 2015

(54) DETERMINING A STYLUS ORIENTATION TO PROVIDE INPUT TO A TOUCH ENABLED DEVICE

(71) Applicant: Lenovo (Singapore) Pte. Ltd., New Tech Park (SG)

(72) Inventors: John Miles Hunt, Raleigh, NC (US); John Weldon Nicholson, Cary, NC (US); Scott Edwards Kelso, Cary, NC (US); Matthew Lloyd Hagenbuch, Durham, NC (US)

(21) Appl. No.: 14/311,727

(22) Filed: Jun. 23, 2014

(51) Int. Cl. G06F 3/0354; G06F 3/041

(52) U.S. Cl. CPC G06F 3/03545; G06F 3/0412

(57) ABSTRACT

In one aspect, a first device includes a display, a processor, and a memory accessible to the processor. The memory bears instructions executable by the processor to receive data from an input device pertaining to the orientation of the input device and, at least in part based on the data, determine whether the input device is positioned to provide input to the first device.

### I. FIELD

The present application relates generally to determining the orientation of an input device for providing input to another device using the input device.

### II. BACKGROUND

Input devices are being used increasingly with other devices such as e.g. tablet computers and smart phones. However, there may be instances when although an input device may be in proximity to the other device, the user still intends to provide touch input from their hand rather than from the input device, but input from the input device is nonetheless still detected and/or processed. Conversely, there may be instances when the user intends to provide input from the input device rather than their hand, but input from their hand is nonetheless still detected and/or processed by the other device e.g. based on the hand's proximity to the other device. There are currently no adequate and/or cost effective solutions for addressing the foregoing.

### SUMMARY

Accordingly, in one aspect a first device includes a display, a processor, and a memory accessible to the processor. The memory bears instructions executable by the processor to receive data from an input device pertaining to the orientation of the input device and, at least in part based on the data, determine whether the input device is positioned to provide input to the first device.

In another aspect, a method includes enabling execution of one or more functions at a first device based on input from a stylus in response to a determination that the stylus is oriented to provide input to the first device, and disabling execution of the one or more functions at the first device based on the input from the stylus in response to a determination that the stylus is not oriented to provide input to the first device.

In still another aspect, a computer readable storage medium that is not a carrier wave includes instructions executable by a processor to receive data from an input device pertaining to the orientation of the input device and, at least in part based on the data, determine whether the input device is oriented to provide input to a first device different from the input device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles;

FIGS. 4 and 5 show example illustrations in accordance with present principles; and

FIGS. 6-8 are example user interfaces (UI) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

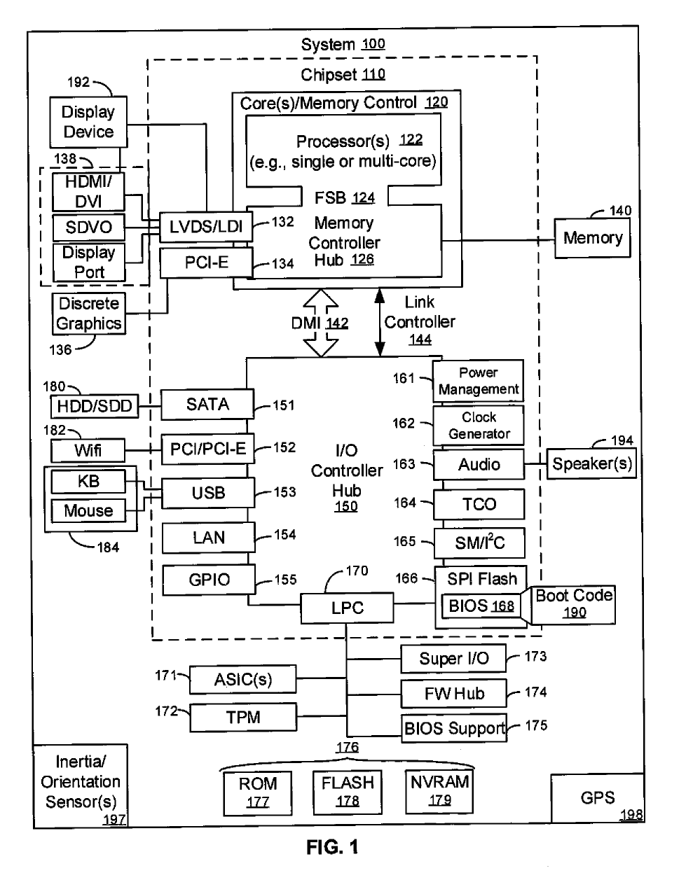

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMIIDVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 is understood to include one or more inertia sensors and/or orientation sensors 197, including e.g. so-called “all-in-one” inertial sensors, a gyroscope for e.g. sensing and/or measuring the orientation of the system 100, and an accelerometer for e.g. sensing acceleration and/or movement of the system 100. The system 100 also includes a GPS transceiver 198 that is configured to e.g. receive geographic position information from at least one satellite and provide the information to the processor 122. However, it is to be understood that another suitable position receiver other than a GPS receiver may be used in accordance with present principles to e.g. determine the location of the system 100.

Still further, and though now shown for clarity, the system may include an audio receiver/microphone in communication with the processor 122 and providing input thereto based on e.g. a user providing audible input to the microphone, as well as a camera which is in communication with and provides input to the processor 122. The camera may be, e.g., a thermal imaging camera, a digital camera such as a webcam, and/or a camera integrated into the system 100 and controllable by the processor 122 to gather pictures/images and/or video.

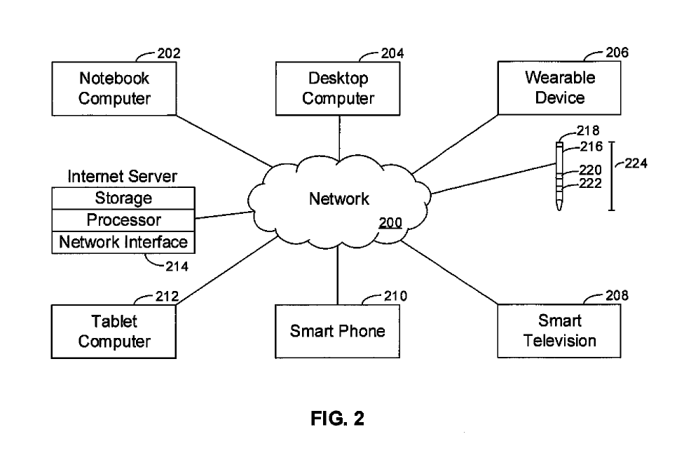

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet, a local area network, a personal network, a peer to peer network, etc. in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, a server 214, and an input device 216 such as e.g. electronic pen and/or stylus. The server 214 may be e.g. an Internet server that may e.g. provide cloud storage accessible to the devices 202-212 and 216. It is to be understood that the devices 202-216 are configured to communicate with each other over the network 200 to undertake present principles.

Further describing the input device 216, it includes one or more inertia sensors and/or orientation sensors 218, including e.g. a gyroscope for e.g. sensing and/or measuring the orientation of the system 100 and an accelerometer for e.g. sensing acceleration and/or movement of the system 100. The input device also may include a GPS transceiver 220 that is configured to e.g. receive geographic position information from at least one satellite and provide the information to the processor 122. However, it is to be understood that another suitable position receiver other than a GPS receiver may be used in accordance with present principles to e.g. determine the location of the system 100. Still further, the input device 216 includes a pressure and/or touch sensor 222 for sensing touch pressure and/or contact of a body part of a user with the sensor 222. Also note that a longitudinal axis 224 is shown that is established by a longitudinal dimension of the stylus 216.

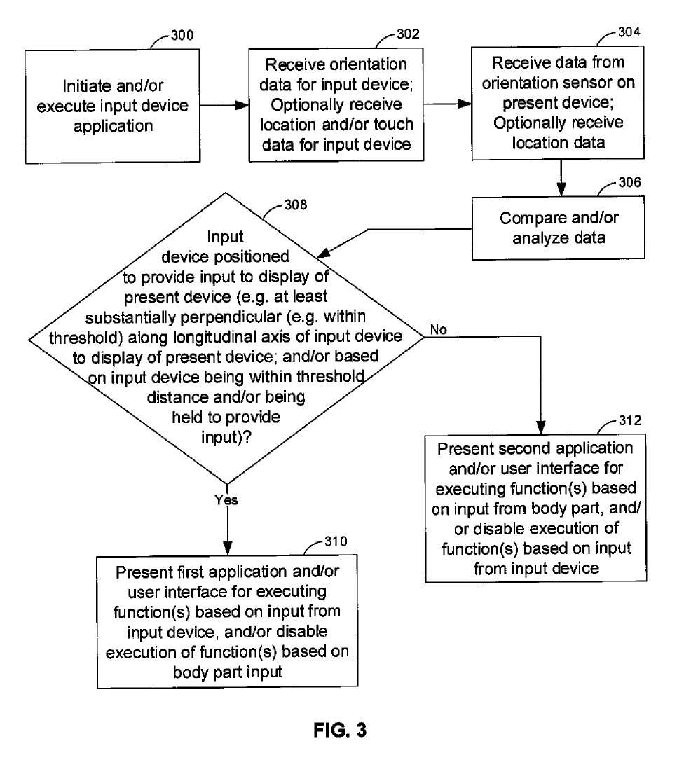

Before moving on to FIG. 3, it is to also be understood that e.g. the wearable device 206 may be an input device in accordance with present principles, and hence may include one or more inertia sensors and/or orientation sensors, a position receiver, and/or pressure and/or touch sensor similar respectively to the elements 218, 220, and 222 described above.

Referring to FIG. 3, it shows example logic that may be undertaken by a device such as the system 100 in accordance with present principles. Beginning at block 300, the logic initiates and/or executes an application for determining the orientation and/or location of an input device such as a stylus in accordance with present principles, and/or an application for receiving input from the input device at a touch-enabled display of a device undertaking the logic of FIG. 3 (referred to below as the “present device”). From block 300 the logic proceeds to block 302 where the logic receives orientation data from the input device pertaining to the orientation of the input device (e.g. relative to the direction of the Earth's gravity at the input device). Also at block 302, the logic may optionally (e.g. if received from the input device and/or based on settings for the present device) receive location data pertaining to the location of the input device, and/or touch sensor data pertaining to whether one or more touch sensors on the input device is being contacted by a body part of a person.

From block 302 the logic proceeds to block 304, at which the logic receives, identifies, and/or determines orientation data from an orientation sensor on the present device that pertains to the orientation of the present device (e.g. relative to the direction of the Earth's gravity at the input device). Also at block 304, the logic may optionally (e.g. based on settings for the present device) receive location data pertaining to the location of the present device, such as e.g. from a GPS transceiver on the present device. Thereafter, the logic moves from block 304 to block 306, where the logic compares the data received at block 302 to the data received at block 304, and/or otherwise analyzes and/or contrasts such data.

Based on the comparison at block 306, the logic then moves to decision diamond 308 where the logic determines whether the input device is positioned and/or oriented to provide input to the display of the present device. The determination at diamond 308 may be made e.g. based on whether the input device is at least substantially perpendicular along a longitudinal axis of the input device to a plane established by the present device and/or specifically to a plane established by the display of the present device, such as e.g. the input device being within a threshold number of degrees (e.g. a predefined and/or user defined threshold) from perpendicular to the plane of e.g. the display.

Furthermore, in some embodiments in addition to the foregoing, the determination made at diamond 308 may be based on additional data such as e.g. data from the input device pertaining to the location of the input device and hence whether the input device is within a threshold distance from the present device, additional data such as e.g. data from the input device pertaining to whether the input device is being held in a certain (e.g. handwriting) position based on input from one or more touch sensors on the input device (e.g. using projected-capacitive sensors, self-capacitive sensors, skin conductivity sensors, and/or a motion-based idle timeout (e.g. if the input device is moving, it may be being positioned for providing input, whereas if it is not moving it may be at a location not near the other device). Thus, e.g. should the input device be oriented substantially perpendicular to the plane established by the display of the present device, but while the input device is relatively distant to the present device (e.g., the present device is laying flat on a table and a user nearby has the input device vertically aligned along its longitudinal axis in a shirt pocket), it is unlikely that the input device at that moment will be used to provide input to the present device and hence a negative determination may be made at diamond 308. As another example, should the input device be oriented substantially perpendicular to the plane established by the display of the present device, but the input device is not being held in a handwriting position but rather is placed between the index and ring finger of a person (e.g. while the person types at a keyboard of the first device using their fingers), it is unlikely that the input device at that moment will be used to provide input to the present device and hence a negative determination may be made at diamond 308.

Regardless, an affirmative determination at diamond 308 causes the logic to proceed to block 310, at which the logic presents a first application and/or first user interface (UI) (e.g. associated with the first application) for executing one or more functions at the present device based on input from the input device (e.g. contact of the input device with the touch-enabled display which may be detected by the touch-enabled display), and/or otherwise enables execution of one or more functions at the present device based on input from the input device (e.g. where those one or more functions are otherwise disabled based on input from the input device). Also at block 310, the logic may disable execution of one or more functions at the present device based on touch input from a body part of a user. E.g., should the input device be oriented to provide input to the present device, there may be instances where contact of a body part with the touch-enabled display is unintentional and hence should be “filtered” or otherwise not processed and/or caused to execute a function at the present device (e.g. if the user is simply resting their palm along an edge of the touch-enable display, not intending to provide input based on the palm contact).

However, a negative determination at diamond 308 instead causes the logic to proceed to block 312, at which the logic presents a second application and/or second user interface (UI) (e.g. associated with the second application) for executing one or more functions at the present device based on input from a body part of a user, and/or otherwise enables execution of one or more functions at the present device based on touch input from a body part of a user (e.g. where those one or more functions are otherwise disabled based on input from a body part of a user). Also at block 312, the logic may disable execution of one or more functions at the present device based on input from the input device. E.g., there may be instances where the input device is detected as providing input (e.g. based on a hover of the input device relatively close to and/or over the display) that was unintentional (e.g. such as the input device being vertically aligned along its longitudinal axis in the shirt pocket of a user) and hence should be “filtered” or otherwise not processed and/or caused to execute a function at the present device.

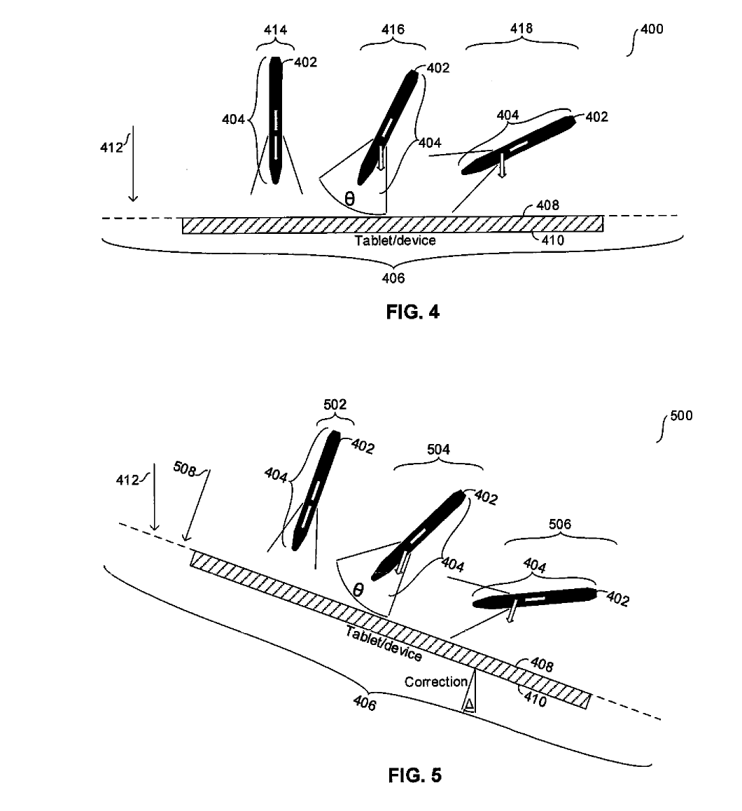

Continuing the detailed description now in reference to FIG. 4, it shows an example illustration 400 of a stylus 402 with its longitudinal axis 404 positioned at various angles relative to a plane 406 established by a display 408 of a tablet computing device 410. Note that the display 408 is not clearly shown in FIG. 4 owing to it facing upward as shown in the illustration 400 toward the stylus 402.

In any case, it is to be understood that in the example illustration 400 shown in FIG. 4, data from an orientation sensor on the tablet computing device 408 need not necessarily be used to determine whether the stylus 402 is positioned to provide input to the display 408 owing to the plane 406 established by the display 408 being substantially if not precisely perpendicular to a vector/direction 412 of the Earth's gravity at the stylus 402 and/or device 410. Accordingly, in such an embodiment an assumption (e.g. determination) may be made by the device 410 about the orientation of the device 410 (that it is at least substantially perpendicular to the direction 412, such as e.g. lying flat on a table), and thus the device 410 may then make a determination as to whether the stylus 402 is oriented to provide input to the display 408 based on orientation data from the stylus 402 but not orientation data from an orientation sensor on the device 410.

Still in reference to FIG. 4, a first representation 414 of the stylus 402 shows the stylus 402 positioned with its longitudinal axis 404 aligned (e.g. in parallel) with the direction 412 of the Earth's gravity, and hence in such a orientation the device 410 may based on orientation data received from the stylus 402 determine that the stylus 402 is positioned (e.g. with its input tip toward the display 408) to provide input to the display 408. A second representation 416 of the stylus 402 shows the stylus 402 positioned with its longitudinal axis 404 not necessarily aligned with the direction 412 of the Earth's gravity but nonetheless still within a threshold number of degrees from being aligned with and/or parallel to the direction 412 (e.g. as represented by the Greek character theta in the representation 416 for the angle of the number of degrees from parallel to the direction 412), and hence in such a orientation the device 410 may based on orientation data received from the stylus 402 determine that the stylus 402 is positioned to provide input to the display 408. Such may be the case, e.g. when a user is holding the stylus 402 at a comfortable, relatively tilted position for providing writing input to the device 410 but still while holding the stylus 402 within the threshold number of degrees.

However, note that a third representation 418 of the stylus 402 shows the stylus 402 positioned with its longitudinal axis 404 not aligned with the direction 412 of the Earth's gravity and/or outside of the threshold number of degrees away from alignment with the direction 412, and hence in such a orientation the device 410 may based on orientation data from the stylus 402 determine that the stylus 402 is not positioned to provide input to the display 408.

Further, e.g. note that whether the longitudinal axis 404 establishes a vector at least a threshold number of degrees away from being aligned with the direction 412 may be based on a default and/or user-specified threshold number of degrees that has been established at the device 410. Also, even though FIG. 4 is two-dimensional, it is to be understood that in practice (e.g. in three dimensions), the threshold number of degrees may be similarly in three dimensions (e.g. to make a threshold three-dimensional threshold “cone” with the tip of the cone e.g. at the portion of the stylus 402 at which the orientation sensor is disposed (e.g. in the middle of the stylus), where the height of the cone may represent the distance from the sensor to the stylus tip, but in any case) to compensate for various stylus tilts and angles in three dimensions that are still within the threshold.

Continuing now in reference to FIG. 5, in the illustration 500 the stylus 402 is again shown in respective representations 502, 504, and 506. However, note that owing to the device 410 and display 408 being tilted at an angle relative to their positioning as shown in the illustration 400, the plane 406 is no longer perpendicular to the direction 412, but is instead perpendicular to a direction 508, with it being understood that the difference in degrees between the plane 406 as shown in FIG. 4 and as shown in FIG. 5 is represented by the angle delta, and hence also corresponds to the difference in degrees between direction 412 and 508.

Thus, it is to be understood that the orientation of the device 410 may be determined based on data from an orientation sensor on the device 410 indicating the angle delta. The device 410 may e.g. by comparing the orientation vectors (e.g. that are with respect to gravity) of the respective devices as detected respectively by the orientation sensors on the stylus 402 and device 410 determine whether the stylus 402 is positioned (e.g. held) relative to the device 410 for providing input such as writing input to the device 410. Put another way, the device 410 may determine a correction factor based on the angle delta from the direction 412 of gravity (e.g. using data from an orientation sensor on the device 410) and also use data received from an orientation sensor on the stylus 402 to determine whether the stylus 402 is positioned for writing when the device 410 is at a tilt as shown in FIG. 5.

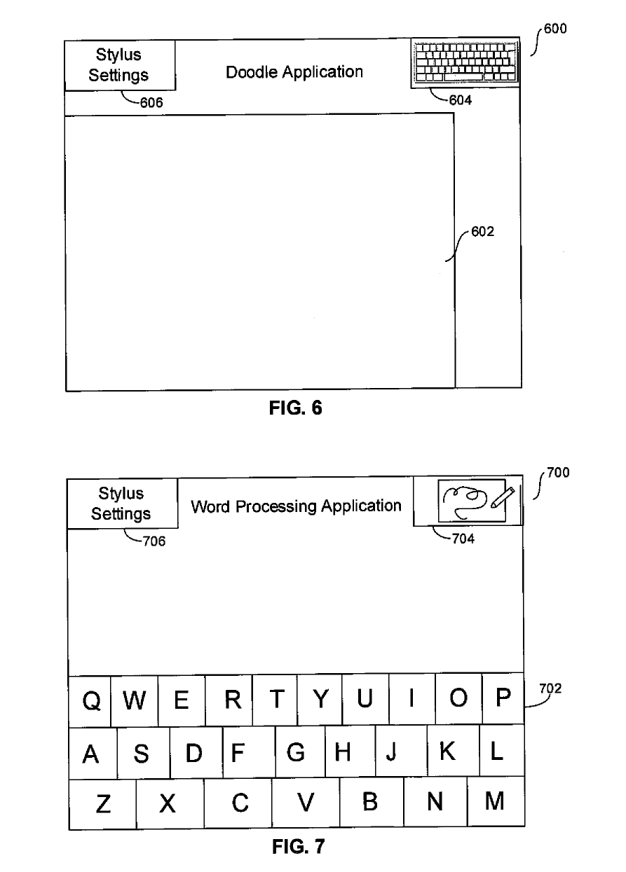

Continuing the detailed description in reference to FIG. 6, it shows an example user interface (UI) 600 presented on a display of a device in accordance with present principles that is associated with an application such as e.g. a handwriting application, drawing application, and/or other application for receiving, processing, and/or presenting input from an input device such as a stylus. The UI 600 thus includes an area 602 to which a user may direct input using a stylus to configure the device presenting the UI 600 to represent the input thereon. The UI 600 also includes a selector element 604 selectable to automatically without further user input cause a e.g. virtual and/or so-called “soft” keyboard to be presented for providing input using e.g. a finger rather than a stylus, though it is to be nonetheless understood that in some embodiments a stylus may also be used to select keys from the keyboard. Last, note that a settings selector element 606 is shown that is selectable to automatically without further user input cause the device to present a settings UI (e.g. such as the UI 800) for configuring settings of an application for undertaking present principles.

Moving on to FIG. 7, it shows an example UI 700 presented on a display of e.g. the same device as described in reference to FIG. 6 and that is associated with e.g. a different application than the one described in reference to FIG. 6, such as e.g. a word processing application and/or Internet browser. But regardless of whether the application is a word processing application, Internet browser, or still another application, it is to be understood that it is configured for receiving, processing, and/or presenting input from a body part of a person such as a finger.

As shown, the UI 700 thus includes an area 702 for providing touch input using e.g. a finger, such as a soft keyboard. The UI 700 also includes a selector element 704 selectable to automatically without further user input cause an area such as the area 602 to be presented, and/or to even cause an entire UI of such an application to be presented, such as the UI 600 described above. Last, note that a settings selector element 706 is shown that is selectable to automatically without further user input cause the device to present a settings UI (e.g. such as the UI 800) for configuring settings of an application for undertaking present principles.

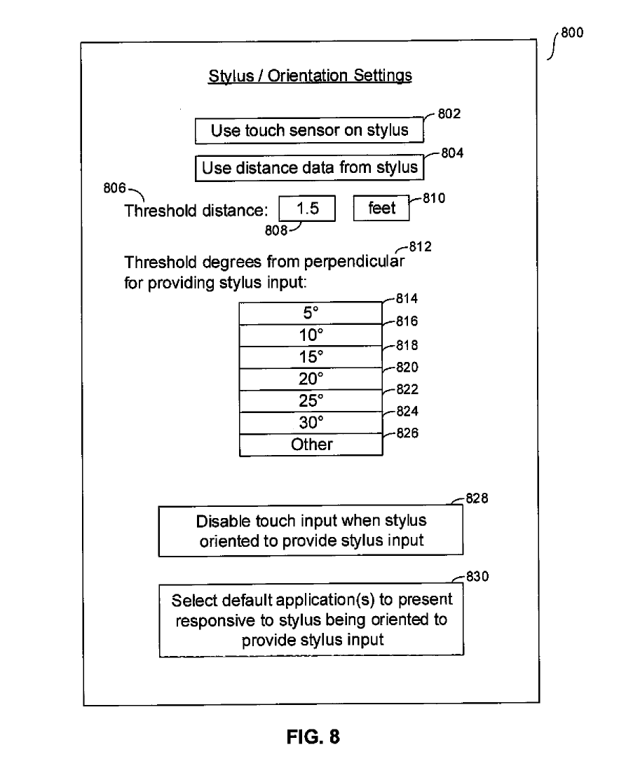

Before moving on to FIG. 8, it is to be understood in joint reference to FIGS. 6 and 7 that the UIs 600 and 700 may be interchangeably presented and/or toggled between based on whether a stylus in communication with the device is detected as being positioned to provide input as described herein. Thus, e.g., a user may provide touch input using the UI 700, decide they would like to take a note using the UI 600 and the stylus, and simply position the stylus for writing e.g. within a proximity to the device presenting the UI 700 to thus automatically without supplemental user input configure the device to present e.g. a stylus handwriting input method editor (IME) and/or change presentation to the UI 600 (e.g. thus removing the UI 700), and then responsive to the device detecting the stylus is no longer positioned for writing may again present a touch-based IME (e.g. a keyboard) and/or the UI 700.

Now in reference to FIG. 8, it shows an example UI 800 for configuring settings of an application for undertaking present principles. The UI 800 includes a first selector element 802 selectable to automatically without further user input configure the device to, in addition to using orientation data from one or more orientation sensors as described herein, also use e.g. touch sensor data received from an input device to determine whether the stylus is positioned for writing. E.g., one or more touch sensors may be juxtaposed on the stylus at positions at which a user is to engage the stylus for providing input (e.g. writing) rather than simply holding it at other portions when not meant to be used to provide input to the device. Thus, based on data from the touch sensors that the user is engaged with (e.g. touching) one or more of the touch sensors and also that the stylus is positioned for providing input as described herein, the device may undertake an action (e.g. presenting the UI 600), whereas e.g. even if the stylus is positioned for writing but at least one of the touch sensors is not engaged by a user the device may decline to undertake the action.

The UI 800 also includes a second selector element 804 selectable to automatically without further user input configure the device to use distance data from the stylus (e.g. in addition to using touch sensor data if the element 802 has also been selected). E.g., there may be instances where it is determined that the device is oriented in at least one respect to provide input to the input device, but the stylus in actuality is still some distance away (e.g. a threshold distance away) from the device and hence not at that moment actually positioned to provide input. Thus, based on (e.g. range) data from a distance sensor (e.g. GPS transceiver) on the stylus, the device may determine whether to undertake an action or decline to do so (e.g. presenting the UI 600) based on not only whether the stylus is oriented e.g. at least substantially with its longitudinal axis in a direction perpendicular to a plane of the display of the device but also based on whether the stylus is within a threshold distance to the device and not e.g. positioned upright in a person's shirt pocket away from the device. Accordingly, a setting 806 is shown for a user to establish such a distance threshold using the input box 808 for inputting a number for the distance and selector 810 for selecting a metric to associate with the number (e.g., feet, centimeters, meters, etc.) e.g. using a drop down box presented on the UI 800 responsive to selection of the selector 810.

Continuing the description of the UI 800, it also includes a setting 812 for a user to set a threshold number of degrees of the input device from being perpendicular to a plane of a display of the device for the device to still determine that it is positioned to provide input. Thus selector elements 814-824 are respectively selectable to configure the device to operate in conformance with the threshold respectively being e.g. five degrees, ten degrees, fifteen degrees, twenty degrees, twenty five degrees, and thirty degrees. Note that a selector element 826 is also shown that is selectable to e.g. cause an overlay window to be presented at which a user may enter another number for the threshold number of degrees.

Furthermore, though not shown the UT 800 or e.g. even a different UI may be presented on the device at which a user may establish (e.g. based on a prompt to do so and/or invocation of a selector element for such purposes) a maximum angle of the input device relative to the other device bearing the display for which the user desires that the other device determine that the input device is positioned to provide input to the display of the other device. E.g., a user may initiate a configuration mode for establishing this maximum angle, may arrange the input device and other device relative to each other at a desired maximum angle, and then may provide input to one or both devices (e.g. based on selection of an e.g. “establish max angle” selector element presented on one or both devices) which may then cause one or both devices to identify their respective angles relative to the Earth's gravity and/or angles relative to the other respective device and store such information (e.g. at the device bearing the display) to establish a maximum angle threshold which may then be used in accordance with present principles.

The UI 800 also includes a selector element 828 selectable to automatically without further user input configure the device to disable and/or decline to perform a function based on touch input received from a user when an input device is determined to be oriented to provide input to the device. Also shown is a selector element 830 selectable to automatically without further user input configure the device to present a listing of applications on the display of the device from which a user may select one or more applications to configure the device automatically without supplemental user input other than positioning an input device to provide input to the present device to present the selected application(s) (e.g. and hence removing another application that may have been presented prior to the determination of the input device being positioned to provide input).

Without reference to any particular figure, it is to be understood that when using distance data in addition to orientation data to determine whether an input device is positioned to provide input to anther device, such distance data may be determined based on e.g. GPS coordinates from the input device (e.g. a detected by a GPS transceiver on the input device), wireless signal strength (e.g. of signals emitted by the input device as detected at the other device using e.g. Bluetooth Low Energy (LE) received signal strength identification (RSSI)), ultrasonic time of flight estimation, trilateration, and/or inertial navigation.

Describing ultrasonic time of flight estimation, in some embodiments two pulses may be emitted by the device other than the input device to determine the distance between the input device and other device, where one pulse may be an infrared (IR) or radio frequency (RF) pulse that will be received by the input device relatively immediately after its emission, and where the second pulse is an ultrasonic pulse traveling e.g. at the speed of sound (it being understood that the speed of sound is not always and everywhere constant and may vary e.g. based on temperature, humidity, etc. and that e.g. climate sensors on one or both devices may be used to determine and/or estimate a local speed of sound based on such variables). The input device may have respective receivers for receiving each of the two pulses and based at least in part on the difference in time between receipt of the IR or RF pulse and receipt of the ultrasonic pulse determine the distance from the input device to the other device from which the pulses were emitted. The distance that is determined may then be communicated to the other device. Before moving on, it is to also be noted that e.g. in some embodiments the pulses and “communication” may go the other way in that the input device may emit the pulses and the other device have the receivers for a determination of time of flight in accordance with present principles.

Describing inertial navigation for determining the distance, various methods may be used such as e.g. the input device using acceleration data from an inertial sensor on the input device tracking the acceleration of the input device to thus determine movement of the input device toward or away from e.g. an initial location such as at or near the other device (so-called “dead-reckoning”). The initial location may be determined and/or reset at the input device responsive to contact of the input device with the other device. Thus, using the initial location the input device may track movement e.g. in three dimensions such that it tracks the input device moving X meters in one direction, Y meters in a second direction, and Z meters in a third direction. In some embodiments, this data may be used in combination with GPS data and/or RSSI data to further ascertain and/or confirm the position of the input device relative to the other device.

Also without reference to any particular figure, it is to be understood that in some embodiments a magnet (e.g. permanent and/or electro-magnetic magnet) may be positioned in an input device (e.g. passive input device) such as a stylus so that the other device to receive input from the input device may sense the orientation of the input device with a magnetometer (e.g. compass) in the other device. The magnet may be placed anywhere in the input device not necessarily e.g. near the tip if the input device is a stylus.

Furthermore, in embodiments where the input device is a stylus, the magnet may be arranged on the input device so that the magnetometer in the other device may sense the polarity of the magnet as positioned in the stylus to determine if the portion of the input device that is about to or in fact is contacting the other device is the “inking” end of the input device for providing e.g. handwriting input, or the “erasing” end of the input device for removing representations of input from the input device that have been presented on the other device. This may be done by the other device by sensing the magnetic field(s) around the other device when the stylus is absent, and then detecting either an increase or a decrease in the magnetic field when the stylus becomes present (e.g. with the increase or decrease depending on the orientation of the magnet and hence orientation of the stylus). Thus, by sensing the orientation of the magnet and hence the stylus, the other device may determine e.g. whether the stylus is oriented with its longitudinal axis at least somewhat parallel to the plane established by the display of the other device and hence not positioned for providing input to the other device (e.g. but rather tucked between a user's fingers while the user types using one or more fingers, or resting on the display itself with its longitudinal axis parallel to the plane of the display while the user provides touch input) and hence neither the inking or erasing ends of the stylus are oriented for providing input to the other device, or whether the stylus is in fact positioned for providing “inking” or “erasing” input.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or another signal per se.

While the particular DETERMINING ORIENTATION OF INPUT DEVICE FOR PROVIDING INPUT TO ANOTHER DEVICE USING THE INPUT DEVICE is herein shown and described in detail, it is to be understood that the subject matter which is encompassed by the present application is limited only by the claims.

1. A first device, comprising:
a display;
a processor; and
a memory accessible to the processor and bearing, instructions executable by the processor to:
receive first data from an input device pertaining to an orientation of the input device;
receive second data representing an orientation of the first device relative to the Earth's gravity; and
at least in part based on the first and second data, determine whether the input device is positioned to provide input to the first device.

2. The first device of claim 1, wherein input device is a stylus and wherein the display a touch-enabled display.

3. The first device of claim 2, wherein the determination whether the input device is positioned to provide input to the first device comprises a determination whether the stylus is positioned to provide input to the touch-enabled display.

4. The first device of claim 3, wherein the determination whether the stylus is positioned to provide input to the touch-enabled display comprises a determination whether a longitudinal axis established by the stylus is at least substantially perpendicular to a plane established by the touch-enabled display.

5. The first device of claim 4, comprising an orientation sensor, wherein data from the orientation sensor is used for the determination whether the longitudinal axis of the stylus is at least substantially perpendicular to the plane established by the touch-enabled display.

6. The first device of claim 5, wherein substantially perpendicular to the plane is within a threshold number of degrees from perpendicular to the plane.

7. The first device of claim 1, wherein the instructions are further executable to, in response to a determination that the input device is positioned to provide input to the first device, enable execution of one or more functions at the first device based on input from the input device, the execution of one or more functions based on input from the input device being otherwise disabled.

8. The first device of claim 1, wherein the instructions are further executable to, in response to a determination that the input device is positioned to provide input to the first device, present a user interface (UI) on the display.

9. The first device of claim 8, wherein the UI is a first UI, and wherein a second UI different from the first UI is removed from the display in response to the determination that the input device is positioned to provide input to the first device.

10. The first device of claim 9, wherein the first UI comprises an area for input from the input device, and wherein the second UI comprises a keyboard.

11. The first device of claim 1, wherein the instructions are further executable to receive data from the input device pertaining to the location of the input device, and wherein the determination of whether the input device is positioned to provide input to the first device comprises a determination based on the data from the input device pertaining to the location of the input device of whether the input device is within a threshold distance to the first device.

12. A method, comprising:
enabling execution of one or more functions at a first device based on input from a stylus in response to a determination that the stylus is oriented to provide input to the first device;
disabling execution of the one or more functions at the first device based on the input from the stylus in response to a determination that the stylus is not oriented to provide input to the first device; and
presenting on the first device at least one of:
a selector element selectable to select use of, in addition to using orientation data, touch sensor data received from an input device to determine whether the stylus is oriented to provide input;
a selector element selectable to select use of, in addition to using orientation data, distance data representing a distance between the stylus and the first device to determine whether the stylus is oriented to provide input.

13. The method of claim 12, comprising, in response to the determination that the stylus is not oriented to provide input to the first device, enabling execution of one or more functions at the first device had on touch input from a body part of a person.

14. The method of claim 12, comprising, in response to the determination that the stylus is oriented to provide input to the first device, disabling execution of one or more functions at the first device based on touch input from a body part of a person.

15. The method of claim 12, wherein the determinations are made at least in part based on data received at the first device from the stylus pertaining to whether at least one touch sensor on the stylus detects the presence of a person.

16. The method of claim 12, wherein the determinations are made at least in part based on a determination of whether the distance between the first device and the stylus is at least one of at a distance threshold and within a distance threshold.

17. The method of claim 12, wherein the determinations are made based at least in part on data from the stylus received at the first device pertaining to the orientation of the stylus, and wherein the determinations are made based at least in part on data from an orientation sensor on the first device pertaining to the orientation of the first device, the data from the stylus being compared to the data from the orientation sensor to determine whether a longitudinal axis established by the stylus is at least within a threshold number of degrees from perpendicular to a plane established by a display of the first device.

18. The method at claim 12, further comprising:
in response to the determination that the stylus is oriented to provide input to the first device, presenting a first user interface (UI) on a touch-enabled display of the first device for receiving input from the stylus; and
in response to the determination that the stylus is not oriented to provide input to the first device; presenting a second UI different front the first UI on the touch-enabled display for receiving touch input from the body of a person, the first UI and the second UI not being simultaneously presented.

19. A computer readable storage medium that is not a transient signal, the computer readable storage medium comprising instructions executable by a processor to:
receive first data from an input device pertaining to an orientation of the input device;
receive second data from an orientation sensor on first device different from the input device; and
at least in part based on the first and second data, determine whether the input device is oriented to provide input to the first device different from the input device.

20. The computer readable storage medium of claim 19, wherein the instructions are executable to:
in response to a determination that the input device is oriented to provide input to the first device, present a first application on a display for receiving input from the input device; and
in response to a determination that the input device is not oriented to provide input to the first device, present a second application on the display different from the first application for receiving input from the body of a person;
wherein the first and second applications are not simultaneously presented.
